(19) United States
(12) Patent Application Publication
(10) Pub. No.: US 2010/0292427 A1
(43) Pub. Date: Nov. 18, 2010

(54) STRUCTURAL MEMBER AND METHOD OF PRODUCING THE STRUCTURAL MEMBER

(75) Inventors: Kazuhiro Ban, Tokyo (JP); Masato Minami, Yokohama-shi (JP); Mayuko Kishi, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/671,034

(22) PCT Filed: Aug. 5, 2008
(86) PCT No.: PCT/JP2008/064380

§ 371 Date: Jan. 28, 2010

(30) Foreign Application Priority Data
Aug. 6, 2007 (JP) 2007-204703

(51) Int. Cl. C08F 136/20

(52) U.S. Cl. 526/336

(57) ABSTRACT

The invention provides a structural member having an excellent ability to prevent the nonspecific adsorption of a biomolecule and a labeling substance to the surface of a substrate, and a method of producing the structural member. The structural member includes a substrate and a polymer present on a surface of the substrate, in which the polymer is formed from a polymer of a multi-vinyl monomer represented by the following general formula (I) or (II), and has a crosslinked structure:

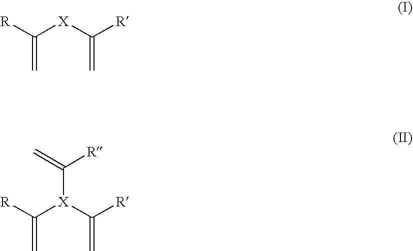

where R, R′, and R″ are independently a hydrogen atom or a methyl group, and X represents a hydrophilic functional group in which fifteen or more atoms are linked in series.

### TECHNICAL FIELD

The present invention relates to a structural member in which a crosslinkable polymer is formed on a substrate, and a method of producing the structural member.

### BACKGROUND ART

In recent years, investigation is being made into how a polymer obtained by polymerizing a multi-vinyl monomer should be used as a biocompatible material. In particular, for the purpose of inhibiting the nonspecific adsorption of contaminant, for example, “Angew. Chem. Int. ED.” 2005, 44, pages 5,505 to 5,509 describes a technology for producing a graft polymer membrane by forming a polymer of polyethylene glycol diacrylate (PEGDA) on a conductive substrate through electrolytic grafting. In addition, “Angew. Chem. Int. ED.” 2005, 44, pages 5,505 to 5,509, describes a technology for performing polymerization by changing the chain length of PEGDA.

Further, in “Angew. Chem. Int. ED.” 2001, 40, pages 1,510 to 1,512, it is described that a membrane formed from a polymer of ethylene glycol dimethacrylate (EGDMA) is produced on the surface of a gold substrate by atom transfer radical polymerization (ATRP), and the degree of crosslinking of the entire membrane is improved by increasing the thickness of the membrane.

### DISCLOSURE OF THE INVENTION

However, the graft polymer membrane described in “Angew. Chem. Int. ED.” 2005, 44, pages 5,505 to 5,509 does not have a high degree of crosslinking because a large peak indicative of the presence of a vinyl group appears in the Raman spectrum of the surface of the substrate. This is considered to originate from the low main chain density of the polymer. Where the membrane does not have a high degree of crosslinking, the ability of the membrane to prevent the nonspecific adsorption of contaminant is reduced.

In addition, in “Angew. Chem. Int. ED.” 2001, 40, pages 1,510 to 1,512, since the length of the multi-vinyl monomer used is short, acrylic groups remain in a certain amount irrespective of the thickness of the membrane, and the hydrophilicity of the polymer is lowered. That is, as in “Angew. Chem. Int. ED.” 2005, 44, pages 5,505 to 5,509, the membrane does not have a high degree of crosslinking, with the result that the ability of the membrane to prevent the nonspecific adsorption of contaminant is lowered.

In view of the foregoing, the present invention is to provide a structural member in which a polymer having a high degree of crosslinking and excellent in an ability to prevent the nonspecific adsorption of biomolecules, labeling substances, etc. to the surface of a substrate is formed. In addition, the present invention is also to provide a method of producing the structural member.

The present invention provides a structural member including a substrate and a polymer present on the surface of the substrate, in which the polymer is formed from a polymer of a multi-vinyl monomer represented by the following general formula (I) or (II), and has a crosslinked structure:

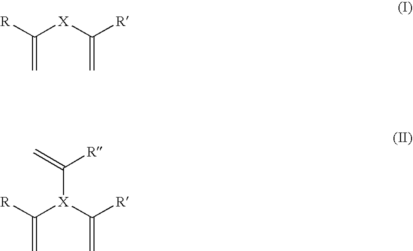

where R, R′, and R″ each independently represent a hydrogen atom or a methyl group, and X represents a hydrophilic functional group in which fifteen or more atoms are linked in series.

According to another aspect of the present invention, a method of producing a structural member is provided including bringing a substrate and a polymerization initiator into contact with each other; and bringing the substrate brought into contact with the polymerization initiator and a multi-vinyl monomer represented by one of the following general formula (I) or (II) into contact with each other to form a polymer by living polymerization:

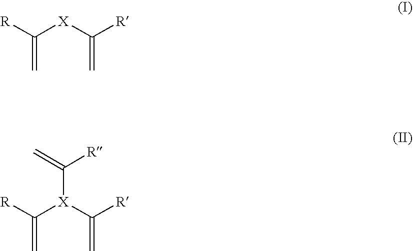

where R, R′, and R″ each independently represent a hydrogen atom or a methyl group, and X represents a hydrophilic functional group in which fifteen or more atoms are linked in series.

According to the present invention, it is possible to provide a structural member having a high degree of crosslinking and a high ability to inhibit the nonspecific adsorption. In addition, it is also possible to provide a method of producing the structural member.

### BRIEF DESCRIPTION OF THE DRAWINGS

FIG. 1 is a view illustrating an example of a structural member of the present invention.

FIG. 2 is a graph illustrating the relationship between the graft density and spacer length of a graft polymer in the present invention.

FIG. 3 is a graph illustrating the relationship between the graft density of the graft polymer and the number of atoms linked in series in a hydrophilic functional group X of the graft polymer in the present invention.

FIG. 4 is a graph illustrating the relationship between the graft density and polyethyleneglycol (PEG) chain length of graft polymers in examples of the present invention.

FIG. 5 is a view illustrating an example of a method of producing a structural member of the present invention.

FIG. 6 is a graph illustrating the results of protein adsorption measurement in the Examples of the present invention.

FIG. 7 is a graph illustrating the results of protein adsorption measurement in the Examples of the present invention.

FIGS. 8A, 8B and 8C are graphs illustrating the results of IR-RAS analysis in the Examples of the present invention.

FIGS. 9A and 9B are graphs illustrating the analytic results of IR-RAS analysis in the Examples of the present invention.

### BEST MODE FOR CARRYING OUT THE INVENTION

The present invention will be described below in detail.

The present invention provides a structural member including a substrate and a polymer present on the surface of the substrate, in which the polymer is formed of a polymer of a multi-vinyl monomer represented by the following general formula (I) or (II), and has a crosslinked structure:

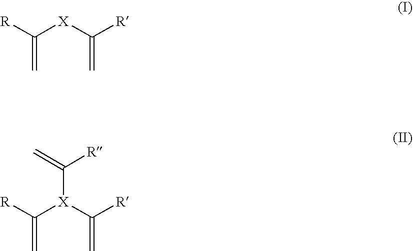

where R, R′, and R″ each independently represent hydrogen atom or a methyl group, and X represents a hydrophilic functional group in which fifteen or more atoms are linked in series.

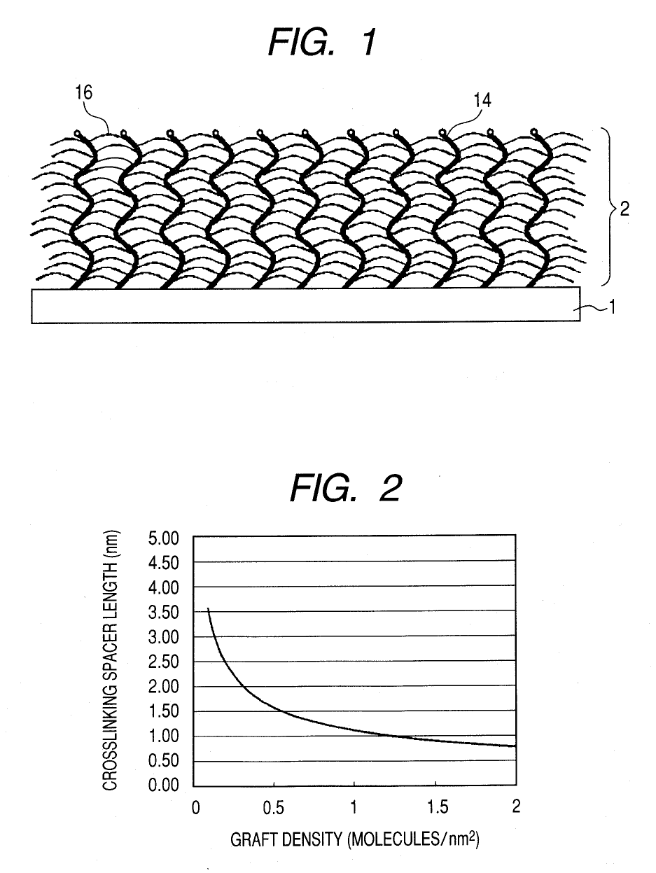

FIG. 1 illustrates an example of the structural member of the present invention.

Hereinafter, each of the portions of which the structural member of the present invention is composed will be described.

### (Substrate)

A substrate 1 has only to be such that the polymer of the multi-vinyl monomer represented by the general formula (I) or (II) described later can be formed on the surface of the substrate.

As a material for forming the surface of the substrate 1, the following can be used: metals such as gold, silver, copper, platinum, aluminium, semiconductors such as CdS and ZnS, metal oxides such as titanium oxide and aluminium oxide, to which amino groups or thiol groups can be bound, and glass, silicon, titanium oxide and ceramics, to which silanol groups can be bound, and ceramics and carbon, to which carboxyl groups can be bound. Alternatively, a plastic can be used which can present carboxyl group by oxidizing the surface with oxygen plasma treatment, UV treatment, etc.

In addition, the substrate 1 may be of an arbitrary shape, and examples of the shape include a flat plate, a curved plate, a particle, a microstructure and a microtiter plate. However, the graft density described later is on the premise that the substrate is flat. Accordingly, with regard to the surface of a curved substrate, an average length of the polymer main chains is calculated in consideration of the curvature. The application of the curved substrate will be described later. In addition, the substrate 1 may be formed from multiple layers.

### (Polymer)

A polymer 2 is a polymer (graft polymer) formed by polymerization of the vinyl groups of the multi-vinyl monomer represented by the general formula (I) or (II), and has a crosslinked structure:

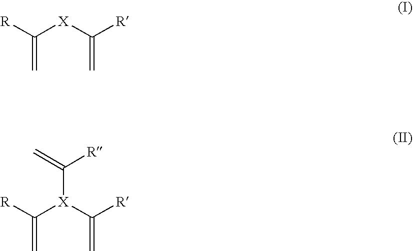

where R, R′, and R″ each independently represent a hydrogen atom or a methyl group, and X represents a hydrophilic functional group in which fifteen or more atoms are linked in series.

The vinyl groups are bonded so that a main chain 14 (hereinafter referred to also as “graft polymer main chain”) is formed. In addition, the hydrophilic functional group X present between the two vinyl groups of the multi-vinyl monomer (in other words, connecting the vinyl groups) serves as a crosslinking spacer 16 for crosslinking the main chains 14.

In the hydrophilic functional group X, fifteen or more atoms are linked in series. That is, when the hydrophilic functional group X has a length in excess of the average length of the main chains 14 of the polymer, the polymer 2 formed on the surface of the substrate 1 comes to be a nonspecific adsorption preventing membrane having a high ability to prevent the nonspecific adsorption. When a multi-vinyl monomer represented by the general formula (II) having three or more vinyl groups is used, fifteen or more atoms are preferably linked between any two arbitrarily combined vinyl groups out of the three or more vinyl groups.

The hydrophilic functional group X preferably contains a polymer of a bifunctional compound or of a cyclic compound. The bifunctional compound is preferably a compound which has a hydroxyl group, an amino group, a carboxyl group, or the like at each of both terminals of an alkylene group, and which is turned into a polymer by the formation of an ether bond, an amide bond, or the like. To be additionally specific, the bifunctional compound is, for example, ethylene glycol, propylene glycol, ethylenediamine, propylenediamine, glycine, β-alanine, lactic acid, or hydroxypropionic acid.

In addition, the cyclic compound is formed of an ether bond, an ester bond, or an amide bond and several alkylene groups, and is polymerized by ring opening. To be additionally specific, the cyclic compound is, for example, ethylene oxide, propylene oxide, cyclooxabutane, butyrolactone, pyrrolidone, caprolactam, a carboxylic anhydride, ethyleneimine, or propylene imine.

(Spacer Length)

A length between two vinyl groups in the multi-vinyl monomer is defined as a spacer length. An average length between the main chains of the polymer is determined from graft density. In the present invention, the relationship between the spacer length and the average length between the main chains is defined. The range of the spacer length is represented as below.

When the average length between the main chains of the polymer is represented by 2r (nm) and an area occupied by one main chain in the polymer is represented by πr², a graft density D equals (πr)⁻¹ (chains/nm²). In this case, it is important that a spacer length SL₍ₓ₊₂₎ (nm) is larger than 2r. That is, the multi-vinyl monomer can be polymerized while the degree of freedom in the polymer main chain is maintained as long as the spacer length falls within the following range.

SL₍ₓ₊₂₎>2r=2×(πD)^{-1/2} (Expression 1)

The polymerization under the above conditions increases the degree of crosslinking of the polymer formed on the substrate. As a result, the polymer can have a high size exclusion characteristic. In addition, the ratio of remaining vinyl groups after the polymerization is reduced. In addition, the concentration of the multi-vinyl monomer is reduced as low as possible at the time of the polymerization, and the ratio of remaining vinyl groups can additionally be reduced.

In addition, the curve in FIG. 2, which is drawn from Expression 1, shows the lower limit for the spacer length SL₍ₓ₊₂₎ with respect to the graft density D in the present invention. That is, in the present invention, a multi-vinyl monomer having a spacer length in the range above the curve in FIG. 2 is used.

A multi-vinyl monomer having spacer length longer than that at the graft density indicated by the curve in FIG. 2 by 1 nm or more is preferably adopted, and a multi-vinyl monomer having spacer length longer than that at the graft density indicated by the curve in FIG. 2 by 2 nm or more is more preferably adopted. Such adoption increases the degree of freedom in the entire polymer, and additionally improves the ability of the membrane to prevent the nonspecific adsorption.

In addition, when the substrate is of a curved shape, a necessary spacer length varies depending on the thickness of the polymer. For example, when the substrate is a fine particle and the radius of structure member of the fine particle including the polymer is (1+r) times (where r represents a ratio of the thickness of the polymer to the radius of the substrate fine particle) as large as the radius of the substrate fine particle, the necessary spacer length is (1+r)² times as large as SL_{(X+2)} in FIG. 2. For example, when a polymer having a thickness of 10 nm is produced on the surface of a fine particle having a diameter of 200 nm, a multi-vinyl monomer having spacer length longer than SL₍ₓ₊₂₎ in FIG. 2 by 21% is needed.

(Number of Atoms of Multi-Vinyl Monomer)

Next, the length (number of atoms) of the hydrophilic functional group X of the multi-vinyl monomer is represented as below when the range of the spacer length in FIG. 2 is applied to the length.

First, the distances between the respective atoms are taken into consideration. When an average bond length between the respective atoms in the spacer is represented by B_{AVE}, the following expression is applied to the number of atoms CL_{X} (atoms) linked in series in the hydrophilic functional group X.

CL_{X}≧2/B_{AVE}X(πD)^{-1/2}−1 (Expression 2)

The standard lengths of various interatomic bonds are as follows: 0.154 nm for a C—C single bond, 0.149 nm for a C—N single bond, and 0.143 nm for a C—O single bond. In addition, the standard bond angle of each of the above bonds is 109.28°, so a value obtained by multiplying the average bond length of each bond by 0.816 (=cos [(180−109.28)/2]°) is an effective bond length (three significant figures, the same is applied to the following).

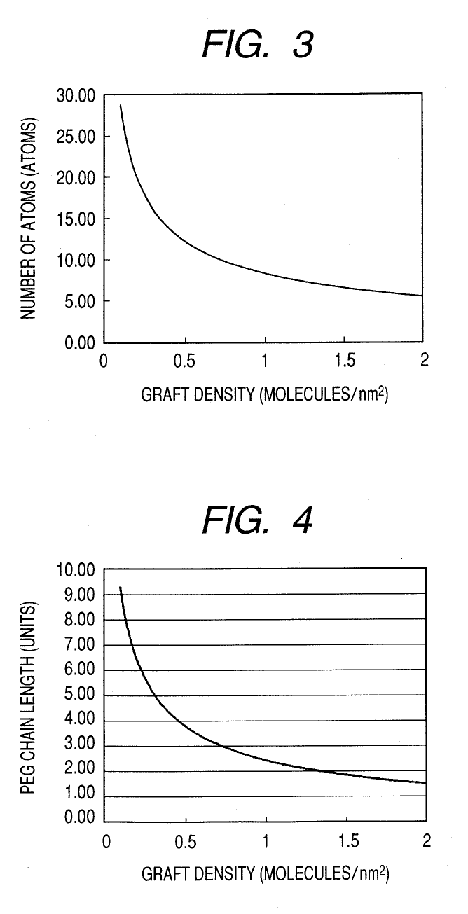

For example, when the hydrophilic functional group is formed by the repetition of C—C single bonds, the number of atoms can be obtained by substituting 0.126 (=0.154×0.816) for B_{AVE} of Expression 2. As a result, the lower limit for the number of atoms CL_{X} with respect to the graft density D is as represented by a curve in FIG. 3. That is, in the present invention, a multi-vinyl monomer having the hydrophilic functional group X the number of atoms of which falls within the range above the curve in FIG. 3 is used.

The graft density of a typical polymer brush obtainable from a monovinyl monomer can be calculated from the density of the polymer in a membrane dried in the air and the thickness of the dried membrane (as described in Macromol. Rapid Commun. 2003, 24, 1,074-1,078). Alternatively, the graft density can be determined also from the swelled thickness of the membrane by the polymers in toluene and the extended chain length of a polymer (as described in Macromolecules 2000, 33, 5,602-5,607 and Macromolecules 2000, 33, 5,608-5,612).

According to the above-mentioned method, a polymer brush obtained by employing living radical polymerization described later has a graft density of 0.17 to 0.7 chains/nm². In particular, when a monovinyl monomer having a small side chain such as methyl methacrylate (MMA) or hydroxyethyl methacrylate (HEMA) is used, a polymer brush having a graft density as high as 0.5 to 0.7 chains/nm² is obtained. However, when a macromonomer such as polyethylene glycol methacrylate, or a monovinyl monomer (with a molecular weight of 200 or more) having a large side chain such as 2-methacryloyloxyethyl phosphorylcholine is used, a polymer brush to be obtained has a graft density of 0.17 to 0.4 chains/nm² (as described in, for example, Langmuir. 2005, 21 (13), 5,980-5,987 or Biomacromolecules 2005, 6, 1,759-1,768).

The multi-vinyl monomer used in the present invention is characterized in that a spacer length between two vinyl groups is longer than an average length between the main chains of the polymer. Therefore, when one vinyl group reacts, any other vinyl groups and spacers serve as a large side chain, and the molecular weight is in excess of 200. Accordingly, it is considered that in the present invention, there is a need for using at least a spacer the length of which exceeds the average length between the main chains of the polymer at 0.4 chains/nm² in order that the degree of crosslinking of the multi-vinyl monomer can be increased.

The graft density of the polymer may be determined by the above method after a crosslinking spacer portion has been cut. However, according to Expression 2 or FIG. 3, based on the above reason, assuming that the graft density of the polymer is 0.4 chain/nm², a multi-vinyl monomer the hydrophilic functional group X of which has a chain length of fifteen atoms or more is applicable. That is, when the number of atoms linked in series in the hydrophilic functional group X is fifteen or more, the bonding of unreacted vinyl groups is considered to be difficult to restrict because the spacer length is longer than the average length between the main chains of the polymer. Accordingly, each multi-vinyl monomer is apt to be easily crosslinked, whereby the ratio of remaining vinyl groups is reduced.

On the other hand, when a multi-vinyl monomer is used in which the number of atoms linked in series in the hydrophilic functional group X is much smaller than fifteen (for example, CL_{X}<12), a phenomenon different from the above occurs. That is, when a vinyl group at one terminal is bonded, a vinyl group at the other terminal and the main chain of the polymer is considered to be difficult to bring into contact with each other owing to the short spacer length. While the vinyl group at the other terminal cannot react, another multi-vinyl monomer is bonded, with the result that the vinyl group at the other terminal cannot be bonded, and is brought into a non-crosslinked state. As a result, each multi-vinyl monomer is difficult to crosslink, and the ratio of remaining vinyl groups increases.

Further, when a multi-vinyl monomer is used in which the number of atoms linked in series in the hydrophilic functional group X is close to and smaller than fifteen (for example, CL_{X}=12 to 14), a phenomenon quite different from the above two examples may occur, though the occurrence is very rare. Since the spacer length and the average length between the main chains of the polymer are substantially equal to each other, the following phenomenon may occur: immediately after a vinyl group at one terminal is bonded, a vinyl group at the other terminal is bonded to the main chain of the polymer. The following situation is anticipated: the extension of the polymer is fast, and the degree of crosslinking becomes high, but the degree of freedom in the polymer main chain and the degree of freedom in the entire polymer are impaired. As a result, each multi-vinyl monomer is very easy to crosslink, and the ratio of remaining vinyl groups in the membrane by the polymer becomes extremely small, but the ability of such membrane to prevent the nonspecific adsorption may be lowered.

A multi-vinyl monomer six atoms or more longer than the number of atoms at the graft density indicated by the curve in FIG. 3 is preferably adopted. That is, the use of a multi-vinyl monomer the hydrophilic functional group X of which has a chain length of 21 atoms or more increases the degree of freedom in the entire polymer, and improves the ability of the membrane to prevent the nonspecific adsorption. A multi-vinyl monomer fifteen or more atoms longer than the number of atoms at the graft density indicated by the curve in FIG. 3 is more preferably adopted. That is, the use of a multi-vinyl monomer the hydrophilic functional group X of which has a chain length of 30 atoms or more increases the degree of freedom in the entire polymer, and additionally improves the ability of the membrane to prevent the nonspecific adsorption.

On the other hand, when the size of a mesh of the crosslinked structure is much larger than that of a molecule the nonspecific adsorption of which is to be prevented, there is a fear that adsorption may occur. Accordingly, a multi-vinyl monomer in which the number of atoms linked in series in the hydrophilic functional group X is excessively large (for example, the number of atoms is 100 or more) may be unsuitable for the present invention.

The curve in FIG. 3 shows a lower limit in the case of a spacer in which C—C single bonds are ranged. In the case of a spacer having a C—N single bond or a C—O single bond, the lower limit increases in accordance with the number of such bonds. A large number of bonds each of which is longer than the above three single bonds are present, and some of them have hydrophilicity. Examples of such bonds include a P—O single bond and an S—O single bond. In the case of a spacer containing any such bonds, the lower limit for the number of atoms linked in series in the hydrophilic functional group X that can be used can be determined in consideration of the bond distance and bond angle.

(Hydrophilic Multi-Vinyl Monomer)

It is preferable that the hydrophilic functional group X possessed by the multi-vinyl monomer exhibits hydrophilicity and contains an oxygen atom or a nitrogen atom.

The term “hydrophilicity” as used in the present invention refers to a state that a contact angle to water is 60° or less, or preferably 40° or less.

In regard to the definition of the hydrophilicity of each unit, there are precedents as follows. A compound satisfying one or more of the following conditions is applicable: the number of hydrogen bond acceptors (HBA's) is six or more, the number of hydrogen bond donors (HBD's) is five or more, or the total of the number of HBA's and the number of HBD's per one molecule of the spacer is nine or more. A compound satisfying two or all of those conditions is also applicable. It is preferable that the number of HBA's is nine or more and the number of HBD's is six or more (International Publication No. WO 2004/025297).

The term “number of hydrogen bond acceptors (HBA's)” refers to the total number of nitrogen atoms (N) and oxygen atoms (O), and the term “number of hydrogen bond donors (HBD's)” refers to the total number of NH and OH groups (C. A. Lipinski et al., Advanced Drug Delivery Reviews 23 (1997), 3-25).

In the present invention, the spacer X of the multi-vinyl monomer represented by the general formula (I) or (II) may be one satisfying the number of HBA's and the number of HBD's.

A typical example of X is an ethylene glycol polymer (hereinafter abbreviated as “PEG”) having high hydrophilicity and most generally used.

In consideration of the structural formula of PEG, B_{AVE} is [(0.154×1+0.143×2)/3]×0.816=0.120. Substituting the value for B_{AVE} in Expression 2, Expression 3 is yielded representing the number of atoms CL_{X} when a multi-vinyl monomer having the PEG at any one of its side chains is used.

CL_{X}≧16.7×(πD)^{-1/2}−1 (Expression 3)

Further, when the number of PEG units is represented by UL_{PEG} (units), UL_{PEG} satisfies the following expression because CL_{X} equals 3UL_{PEG}+1.

UL_{PEG}≧5.56×(πD)^{-1/2}−0.667 (Expression 4)

In addition, a curve in FIG. 4, which is drawn from Expression 4, shows the lower limit for the spacer length UL_{PEG} with respect to the graft density D in the present invention. That is, a multi-vinyl monomer is used having PEG units the number of which falls within the range above the curve in FIG. 4

Examples of the PEG-containing multivinyl monomer that can be used in the present invention include, but are not limited to, polyethyleneglycol divinyl ether, polyethyleneglycol diallyl ether, polyethyleneglycol diisopropenyl ether, polyethyleneglycol diacrylate, and polyethyleneglycol dimethacrylate.

Four or more PEG units are preferably applied. As long as the number of PEG units is four or more, even when one vinyl group bonded, the degree of freedom in an unreacted vinyl group is hardly restricted because of a long side chain, so the efficiency at which the unreacted vinyl group reacts is improved. In addition, when the number of PEG units is four or more, the monomer is apt to easily become hydrophilic when turned into a polymer in consideration of a ratio between the main and side chains of the polymer.

Six or more PEG units are preferably applied. That is, the use of a spacer two or more units longer than the number of units at the graft density indicated by the curve in FIG. 4 increases the degree of freedom in the entire polymer, and improves the ability of the membrane to prevent the nonspecific adsorption. Nine or more PEG units are more preferably applied. That is, the use of a spacer five or more units longer than the number of units at the graft density indicated by the curve in FIG. 4 increases the degree of freedom in the entire polymer, and additionally improves the ability of the membrane to prevent the nonspecific adsorption.

A monomer having PEG in part of X can also be used as the multi-vinyl monomer. Examples of the monomer include, but are not limited to, monomers each containing, for example, a copolymer of ethylene glycol and propylene glycol, a copolymer of ethylene glycol and tetramethylene glycol, a copolymer of ethylene glycol and ethyleneimine, a copolymer of ethylene glycol and propyleneimine, a copolymer of ethylene glycol and tetramethyleneimine, a copolymer of ethylene glycol and glycerol, a copolymer of ethylene glycol and trimethylolpropane, a copolymer of ethylene glycol and pentaerythritol, a copolymer of ethylene glycol and triethanolamine, or a copolymer of ethylene glycol and tris(2-aminoethyl)amine, or a derivative of any one of the above compounds in X.

A monomer having an ethyleneimine polymer, as well as the above PEG, in part of X can be used as the multi-vinyl monomer. Examples of the monomer include, but are not limited to, monomers each containing, for example, ethylenimine polymer, a copolymer of ethylenimine and ethylene glycol, a copolymer of ethylenimine and propylene glycol, a copolymer of ethylenimine and tetramethylene glycol, a copolymer of ethylenimine and propyleneimine, a copolymer of ethylenimine and tetramethyleneimine, a copolymer of ethylenimine and glycerol, a copolymer of ethylenimine and trimethylolpropane, a copolymer of ethylenimine and pentaerythritol, a copolymer of ethylenimine and triethanolamine, or a copolymer of ethylenimine and tris(2-aminoethyl)amine, or a derivative of any one of the above compounds in X.

A multi-vinyl monomer containing a cation or an anion in X can also be used.

The use of a multi-vinyl monomer containing a cation can prevent the adsorption of a molecule bearing a cation on its surface by charge repulsion. In addition, the use of a multi-vinyl monomer containing an anion can similarly prevent the adsorption of a molecule bearing an anion on its surface.

Examples of the cation-containing multi-vinyl monomer include, but are not limited to, an amine-containing compound and a quaternary ammonium ion-containing compound.

In addition, examples of the anion-containing multi-vinyl monomer include, but are not limited to, a carboxyl ion-containing compound, a phosphate ion-containing compound, and a sulfite ion-containing compound.

A multi-vinyl monomer containing an amphoteric ion in X can be preferably used.

The presence of a cation and an anion in a molecule of the multi-vinyl monomer can efficiently prevent the nonspecific adsorption. It has been already known that, in a monomethacrylate monomer, a betaine-containing compound, a phosphorylcholine-containing compound, or the like is subjected to living radical polymerization, and the effect of inhibiting the nonspecific adsorption is exerted.

Examples of the amphoteric ion-containing multi-vinyl monomer include, but are not limited to, a betaine-containing compound, a phosphorylcholine-containing compound, and a compound obtained by the coupling of amino acids. The term “betaine” is a generic name for compounds (inner salts) each having the following characteristics: the compound has positive charge and negative charge at positions not adjacent to each other in any one of its molecules, a hydrogen atom capable of dissociation is not bonded to an atom having positive charge (a cation structure such as a quaternary ammonium, a sulfonium, or a phosphonium is adopted), and an entire molecule of the compound does not have charge.

A multi-vinyl monomer yielded by acid-base reaction such as a methacryloyl-polyethyleneglycol acid phosphate diethylaminoethyl methacrylate half salt obtained by mixing acid phosphooxypolyethylene glycol monomethacrylate and diethylaminoethyl monomethacrylate can also be used in the present invention.

It should be noted that a polymer may be formed by polymerizing a mixture of a plurality of multi-vinyl monomers out of those listed above. Alternatively, a polymer may be formed by mixing any one of the above multi-vinyl monomers and a desired monovinyl monomer.

(Crosslinked Structure)

When living polymerization is carried out using a multi-vinyl monomer, a side chain of the multi-vinyl monomer serves as a crosslinking spacer, whereby a crosslinked structure is spontaneously formed. This is because the living polymerization has the following characteristic: a growing terminal of a polymer is always active (living) in polymerization, so polymers having a uniform chain length can be obtained. However, the degree of crosslinking largely varies depending on the chain length of the monomer and the graft density. The degree of crosslinking is made clear by determining a ratio of remaining vinyl groups to all the vinyl groups of the polymerized multi-vinyl monomer. The ratio of the remaining vinyl groups can be determined by such a spectroscopic approach as described later. The polymer of the present invention preferably contains the remaining vinyl groups in a ratio of 15% or less because of the following reason: when the ratio of the remaining vinyl groups is 15% or more, the reaction activity of the surface of a substrate is high, so the nonspecific adsorption of, for example, a biomolecule and a labeling substance to the surface of the substrate occurs.

The ratio of the remaining vinyl groups is more preferably 2% to 15%. When the ratio of the remaining vinyl groups is 2% or less, an average length between the main chains of the polymer is assumed to be at the same level as the crosslinking spacer length of the multi-vinyl monomer. The extension of the polymer is fast, and the degree of crosslinking becomes high, but the degree of freedom in the polymer main chain and the degree of freedom in the entire polymer may be impaired. As a result, the nonspecific adsorption of, for example, a biomolecule and a labeling substance to the surface of the substrate may occur. When the polymer contains the remaining vinyl groups in a ratio of 2% to 15%, the polymer is considered to have a higher ability to prevent the nonspecific adsorption.

The polymer may have an arbitrary thickness as long as the thickness falls within a generally range of a membrane thickness based on the bonding of a polymer from the surface of the substrate. The polymer preferably has a thickness of 0.5 nm or more after having been dried. When the thickness is less than 0.5 nm, a size exclusion effect cannot be obtained, and the nonspecific adsorption is liable to occur in some cases, or, depending on the size of a polymerization initiator, the polymer comes to be absent in some cases.

The thickness is more preferably 0.5 nm or more and 10 nm or less. Most part in a membrane formed from the polymer in the present invention has a crosslinked structure. In other words, the membrane has a three-dimensional crosslinked structure, and even the membrane with an extremely small thickness has a size exclusion effect as compared with a graft membrane of a monovinyl monomer which merely extends in the lengthwise direction relative to a substrate. This is advantageously used in a large number of biosensors. For example, in surface plasmon resonance (SPR), localized surface plasmon resonance (LSPR), or a magnetic sensor, the surface of an element is a portion having the highest sensitivity. However, it is essential to prevent the nonspecific adsorption in such biosensors. Accordingly, a thickness of several tens of nanometers to several hundreds of nanometers has been conventionally needed. The use of the present invention can minimize the loss of portions having high sensitivity and efficiently prevent the nonspecific adsorption.

A method of producing a structural member of the present invention includes:

(i) bringing a substrate and a polymerization initiator into contact with each other; and

(ii) bringing the substrate brought into contact with the polymerization initiator and a multi-vinyl monomer represented by the following general formula (I) or (II) into contact with each other to form a polymer by living polymerization:

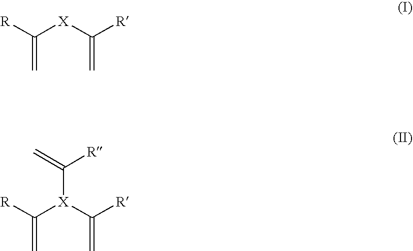

where R′ and R″ each independently represent a hydrogen atom or a methyl group, and X represents a hydrophilic functional group in which fifteen or more atoms are linked in series.

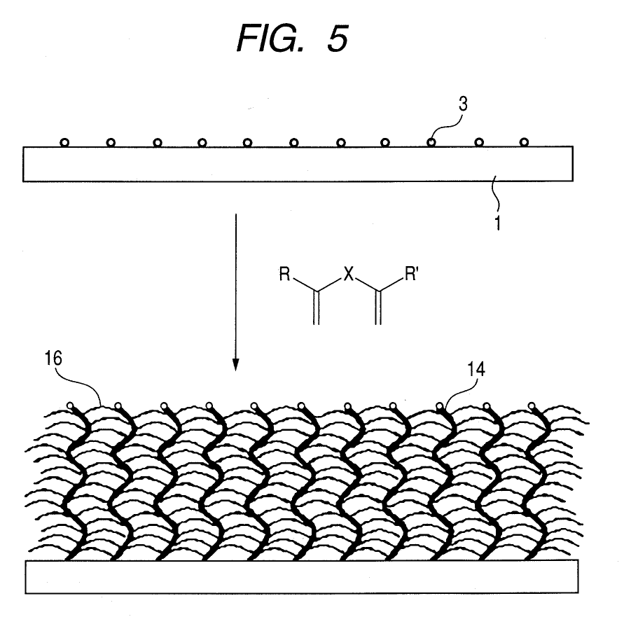

The method of producing a structural member of the present invention will be described with reference to FIG. 5.

In the step (i), the polymerization initiator for initiating the polymerization of the multi-vinyl monomer represented by the general formula (I) or (II) is brought into contact with the substrate. Thus, as in FIG. 5, a polymerization initiator 3 is fixed to the surface of the substrate 1.

In the step (ii), the substrate 1 obtained in the step (i) and the multi-vinyl monomer represented by the general formula (I) or (II) are brought into contact with each other so that the living polymerization is performed. Thus, the polymer is formed.

Living radical polymerization out of various types of living polymerization is preferable. Hereinafter, the living radical polymerization method will be described in detail.

(Living Radical Polymerization)

In general, the living radical polymerization has the following characteristics: a polymer to be synthesized has a small molecular weight distribution, and a polymer layer can be grafted at high density on a substrate. Accordingly, the living radical polymerization of a multi-vinyl monomer having an appropriate chain length allows the respective vinyl groups to react at initiation points on the substrate to provide a high-density crosslinked membrane on the substrate. Examples of the living radical polymerization method include methods each utilizing any one of the following types of polymerization.

(1) Atom Transfer Radical Polymerization (ATRP) in which an organic halide or the like is used as an initiator and a transition metal complex is used as a catalyst;
(2) Nitroxide Mediated Polymerization (NMP) in which a nitroxide compound or the like is used as a radical scavenger; and
(3) Light initiator polymerization in which dithiocarbamate or the like is used as a radical scavenger.

In the present invention, the functional structural member may be produced by any of the above methods, but atom transfer radical polymerization is preferable due to easiness of control.

(Atom Transfer Radical Polymerization)

In the case where the living radical polymerization is atom transfer radical polymerization, organic halides represented by chemical formulae (1) to (3) or sulfonyl halide compounds represented by chemical formula (4) can be used as a polymerization initiator.

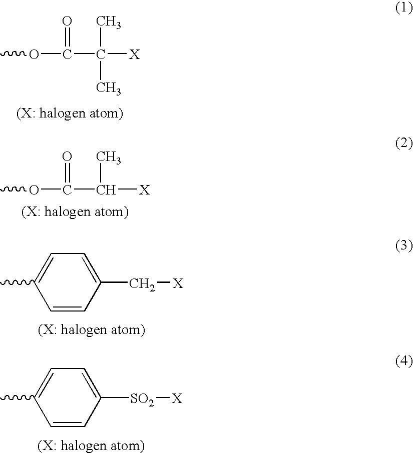

After the substrate into which an atom transfer radical polymerization initiator has been introduced is added to a reaction solvent, a multi-vinyl monomer and a transition metal complex are added and atom transfer radical polymerization is performed in a reaction system the inside of which has been replaced with an inert gas. Thus, the polymerization is able to progress while keeping graft density constant. That is, the polymerization is able to proceed in a living fashion and the polymer can be grown up almost uniformly on the substrate.

The reaction solvent is not particularly limited, and the following may be used: for example, dimethylsulfoxide, dimethylformamide, acetonitrile, pyridine, water, methanol, ethanol, propanol, butanol, pentanol, hexanol, heptanol, cyclohexanol, methylcellosolve, ethylcellosolve, isopropylcellosolve, butylcellosolve, acetone, methyl ethyl ketone, methyl isobutyl ketone, cyclohexanone, ethyl acetate, butyl acetate, ethyl propanoate, trioxane, and tetrahydrofuran. These may be used singly or in combination.

As an inert gas, a nitrogen gas or an argon gas can be used.

The transition metal complex to be used is composed of a metal halide and a ligand. As a metal in the metal halide, transition metals from Ti of atomic number 22 to Zn of atomic number 30 are preferable, and Fe, Co, Ni, Cu are more preferable. OF those, cuprous chloride and cuprous bromide are preferable.

The ligand is not particularly limited as long as it can coordinate with a metal halide, and the following may be used as the ligand: for example, 2,2′-bipyridyl, 4,4′-di-(n-heptyl)-2,2′-bipyridyl, 2-(N-pentyliminomethyl)pyridine, (−)-sparteine, tris(2-dimethylaminoethyl)amine, ethylene diamine, dimethylglyoxime, 1,4,8,11-tetramethyl-1,4,8,11-tetraazacyclotetradecane, 1,10-phenanthroline, N,N,N′,N″,N″-pentamethyldiethylenetriamine, and hexamethyl(2-aminoethyl)amine.

Preferably, the amount of the transition metal complex to be added is 0.001 to 10% by weight, preferably 0.05 to 5% by weight, based on the multi-vinyl monomer.

After the completion of the polymerization, the substrate is sufficiently cleaned with the reaction solvent as described above, whereby a structural member in which the polymer is grafted can be obtained.

(Nitroxide Mediated Polymerization)

In the case where the living radical polymerization is nitroxide mediated polymerization, a nitroxide compound represented by Chemical Formulae (5) to (8) can be used as a polymerization initiator.

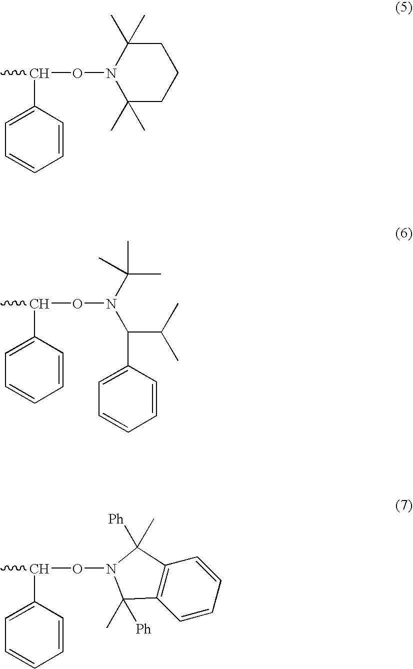

After the substrate into which a nitroxide mediated polymerization initiator has been introduced is add to a reaction solvent, a multi-vinyl monomer is added and nitroxide mediated polymerization is performed in a reaction system the inside of which is replaced with an inert gas. Thus, the polymerization is able to proceed while keeping graft density constant. That is, the polymerization is able to proceed in a living fashion and the polymer can be grown almost uniformly on the substrate.

The reaction solvent is not particularly limited and the same solvents as mentioned above can be used. The solvents may be used singly or in combination.

As the inert gas, a nitrogen gas or an argon gas can be used.

After the completion of the polymerization, the substrate is sufficiently cleaned with the reaction solvent as described above, whereby a structural member in which the polymer is grafted can be obtained.

(Light Initiator Polymerization)

In the case where the living radical polymerization is light initiator polymerization, an N,N-dithiocarbamine-type compound represented by Chemical Formula (8) can be used as a polymerization initiator.

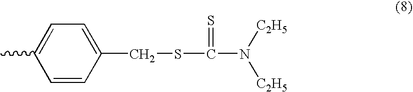

After the substrate into which a light initiator polymerization initiator has been introduced is add to a reaction solvent, a multi-vinyl monomer is added and light initiator polymerization is performed by irradiation with light in a reaction system the inside of which is replaced with an inert gas. Thus, the polymerization is able to proceed while keeping graft density constant. That is, the polymerization is able to proceed in a living fashion and the polymer can be grown almost uniformly on the substrate.

The reaction solvent is not particularly limited and the same solvents as mentioned above can be used. The solvents may be used singly or in combination.

As the inert gas, a nitrogen gas or an argon gas may be used.

The wavelength of the light used for irradiation may vary depending on the type of light initiator polymerization initiator to be used. When grafting is performed on the surface of the substrate having a light initiator polymerization initiator represented by Chemical Formula 9, light initiator polymerization desirably proceeds by irradiating the reaction system with light having a wavelength of 300 nm to 600 nm.

The polymerization temperature is preferably a temperature not higher than room temperature to suppress side reaction. However, it is not limited to the temperature range as long as the same effect can be obtained.

After the completion of the polymerization, the substrate is sufficiently cleaned with the reaction solvent as described above, whereby a structural member in which the polymer is grafted can be obtained.

(Method of Evaluating Polymer)

In the present invention, the surface of a substrate is modified with a polymer. Accordingly, the polymer can be evaluated by analyzing the surface of the substrate or by analyzing a partially decomposed product of the polymer formed on the surface of the substrate.

The hydrophilicity of the polymer can be evaluated by measuring, for example, the contact angle to water.

The degree of crosslinking of the polymer can be evaluated by analyzing a ratio of unreacted C—C double bonds to the reacted multi-vinyl monomer by a method such as infrared absorption (IR) spectroscopy or X-ray photoelectron spectroscopy (XPS). In particular, using infrared reflection-absorption spectroscopy (hereinafter “IR-RAS”), a thin membrane on a substrate can be analyzed with high sensitivity. IR-RAS is a measure to analyze the orientation of a thin membrane in a general fashion by detecting the reflection of polarized light, and it has been known that in the polymer in the present invention, a peak is obtained in proportion to a dried membrane thickness of several nanometers to several tens of nanometers. Accordingly, IR-RAS is useful in measuring remaining vinyl groups. In this case, when the multi-vinyl monomer is an acrylate or a methacrylate, the remaining vinyl groups can be quantitatively determined by using a peak derived from a carbonyl group as an internal standard. Specific examples of the determination will be described in the Examples.

In addition, the relationship between the distortion and stress of the polymer can be analyzed with, for example, a rheometer to determine whether the polymer has a crosslinked structure.

The density of the polymer can be evaluated by, for example, the following method. The dried membrane thickness is measured by ellipsometry, and the weights of the substrate before and after the formation of the polymer are measured. The crosslinking spacer is cut so that the polymer is cut out of the substrate. After that, the molecular weight of the polymer main chain is measured by gel permeation chromatography (GPC). The density of the polymer can be evaluated on the basis of the dried membrane thickness, and the molecular weight, and the number of molecules, of the polymer main chain obtained from the foregoing measurement.

The length and type of multi-vinyl monomer used in the formation of the polymer can be evaluated by a combination of two or more of nuclear magnetic resonance (NMR) spectroscopy, infrared absorption (IR) spectroscopy, X-ray photoelectron spectroscopy (XPS), time-of-flight secondary ion mass spectroscopy (TOF-SIMS), and the like. Alternatively, the evaluation can be made in combination with an atomic force microscope (AFM).

The effect of preventing the nonspecific adsorption of protein to the polymer can be evaluated by means of, for example, fluorescent observation, fluorometry, enzyme-linked immunosorbent assay (ELISA), radioimmunoassay (RIA), SPR, LSPR, or quartz-crystal oscillator microbalance (QCM).

### EXAMPLES

The present invention will be described more specifically by way of Examples described below.

### Example 1

(Step of Introducing an ATRP Initiator onto a Gold Thin-Film Substrate)

A gold thin-film substrate of an SIAkit Au (thickness: 0.3 mm; size: 12 mm×10 mm; manufactured by Biacore) was placed in a capped container, and the container was subjected to ultrasonic cleaning. The substrate was cleaned by sequentially placing acetone, isopropyl alcohol, and ultrapure water into the capped container. After having been dried by nitrogen purge, the gold thin-film substrate was set in a UV/O₃ cleaning apparatus UV-1 (manufactured by SAMCO, Inc.), and was subjected to UV/O₃ cleaning at 120° C. for 10 minutes. The gold thin-film substrate and ultrapure water were placing into the capped container again, and the container was subjected to ultrasonic cleaning.

Next, 10 ml of ethanol and 3.5 mg of 11-mercapto-undecyl 2-bromo-2-methyl-propionate represented by Chemical Formula 9 (manufactured by NARD institute, ltd.) were added to the capped container, whereby a solution of an ATRP initiator was prepared. The cleaned gold thin-film substrate was washed with ethanol, and was then placed in the capped container, and the mixture was stirred in a rotary incubator. Further, the substrate was cleaned with ethanol overnight, whereby the gold thin-film substrate on which a self-assembly monolayer (hereinafter referred to as “SAM”) had been formed with the ATRP initiator was produced. After drying by nitrogen purge, the dried membrane thickness of the SAM was measured with an ellipsometer M-2000 (manufactured by J. A. Woollam Co., Inc.) and found to be 1.86±0.08 nm, provided that the substrate is preferably washed with a solvent to be used in a polymerization process as a next stage without being dried before being placed in a reaction vessel for polymerization.

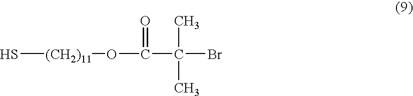

(Step of Polymerizing Nonaethylene Glycol Diacrylate (NEGDA; the Number of EG Units: Nine) on the Surface of SAM by Means of an ATRP Initiator by Employing an ATRP Method)

The substrate on which the SAM had been formed was placed in a Schlenk flask for reactions, and was fixed so as not to impinge on the wall surface of the flask. Next, the Schlenk flask was immersed in ice water, and 93 mg of 2,2′-bipyridyl and 7.6 g of an NEGDA monomer represented by Chemical Formula (10) (trade name: NK Ester A-400, manufactured by Shin-Nakamura Chemical Co., Ltd.) were added to the flask. Then, a mixture of methanol and ultrapure water at a weight ratio of 4:1 was added to the flask so that the total amount of the resultant mixture was 30 ml. The inside of a reaction system was replaced with nitrogen by encapsulating nitrogen in the Schlenk flask with a syringe. 39 mg of cuprous bromide was added to the mixture, and the inside of the flask was additionally replaced with nitrogen. After that, ATRP was initiated at 23° C. After the reaction had been performed for 24 hours, the reaction product was exposed to the air so that the reaction was completed. Thus, a structural member was obtained.

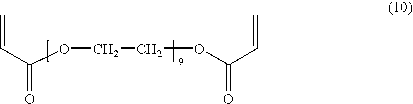

After the completion of the reaction, the structural member and methanol were loaded into the capped container, and the structural member was cleaned with a rotary incubator overnight. Then, the structural member was similarly cleaned with ultrapure water overnight. After drying by nitrogen purge, the thickness of the polymer was measured in the same manner as described above and found to be 0.7±0.1 nm (excluding the thickness of the SAM). In addition, the contact angle to water was measured and found to be 25±2°.

(Protein Adsorption Measurement for the Polymer)

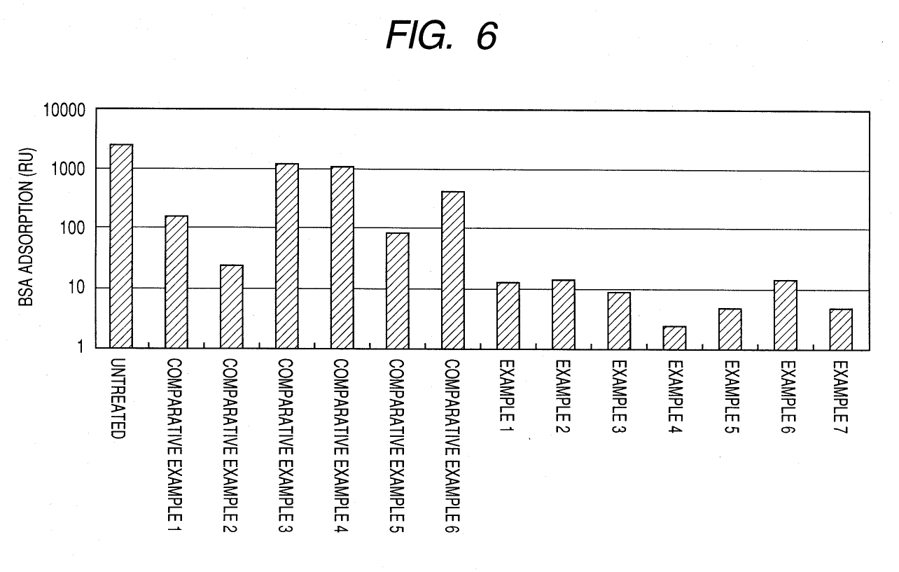

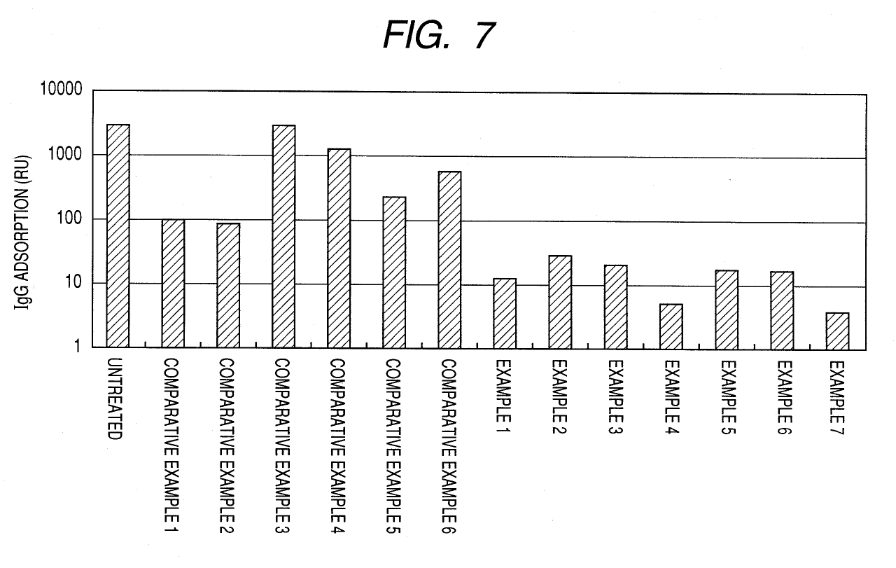

Protein adsorption measurement was performed with a Biacore X (manufactured by GE Healthcare Bio-Sciences K.K.) based on SPR. A sensor chip was made up by using the resultant NEGDA polymer according to the method of the instructions attached to the SIAkit Au, and was inserted into the Biacore X by a predetermined method. The surface of the substrate and a flow path were cleaned with a phosphate buffered saline (having a pH of 7.4) by a predetermined method, and then a sensorgram was initiated at a flow rate of 20 μl/min. After it was confirmed that the signal came to be flat, a protein solution was injected and was allowed to flow for 2 minutes. A 4% bovine serum albumin (BSA) solution or a 1% bovine immunoglobulin G (BIgG) solution was used as the protein solution. The difference between a signal 5 minutes after 40 μL of each protein solution was allowed to flow, and a signal before the solution was allowed to flow, was measured three times, and the average of the three values was defined as a protein adsorption. FIGS. 6 and 7 show the results. The amount of adsorption is represented in an RU unit, where 1 RU is nearly equal to 1 pg/mm².

### Example 2

(Polymerizing Tetraethylene Glycol Dimethacrylate (TEGDMA; the Number of EG Units: 4) on the Surface of SAM by Means of an ATRP Initiator by Employing an ATRP Method)

ATRP was performed for 8 hours in the same manner as in Example 1 by adding 1.01 g of a TEGDMA monomer represented by Chemical Formula (11) (trade name: NK Ester 4G, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 4.5±0.2 nm (excluding the thickness of an SAM). In addition, the contact angle to water was measured and found to be 35±1°. FIGS. 6 and 7 show the results of the protein adsorption measurement.

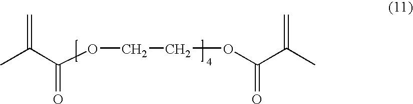

### Example 3

(Polymerizing Hexaethylene Glycol Dimethacrylate (HEGDMA; the Number of EG Units: 6) on the Surface of SAM by Means of an ATRP Initiator by Employing an ATRP Method)

ATRP was performed for 7 hours in the same manner as in Example 1 by adding 1.24 g of a HEGDMA monomer represented by Chemical Formula (12) (manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 7.3±0.2 nm (excluding the thickness of an SAM). In addition, the contact angle to water was measured and found to be 32±2°. FIGS. 6 and 7 show the results of the protein adsorption measurement.

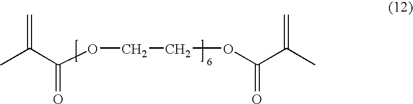

### Example 4

(Polymerizing Nonaethylene Glycol Dimethacrylate (NEGDMA; the Number of EG Units: 9) on the Surface of SAM by Means of an ATRP Initiator by Employing an ATRP Method)

ATRP was performed for 14 hours in the same manner as in Example 1 by adding 1.61 g of a NEGDMA monomer represented by Chemical Formula (13) (trade name: NK Ester 9G, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 4.1±0.3 nm (excluding the thickness of an SAM). In addition, the contact angle to water was measured and found to be 25±3°. FIGS. 6 and 7 show the results of the protein adsorption measurement.

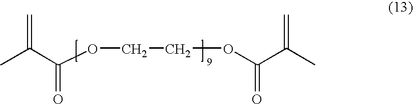

### Example 5

(Polymerizing Polyethylene Glycol Dimethacrylate (PEGDMA; the number of EG Units: 23) on the Surface of SAM by Means of an ATRP Initiator by Employing an ATRP Method)

ATRP was performed for 24 hours in the same manner as in Example 1 by adding 3.41 g of a PEGDMA monomer represented by Chemical Formula (14) (trade name: NK Ester 23G, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 5.2±0.1 nm (excluding the thickness of an SAM). In addition, the contact angle to water was measured and found to be 20±3°. FIGS. 6 and 7 show the results of the protein adsorption measurement.

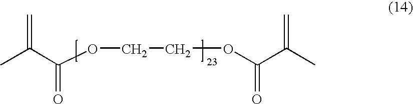

### Example 6

(Polymerizing Ethoxylated Glycerin Triacrylate (the total number of EG Units: 9) on the Surface of SAM by Means of an ATRP Initiator by Employing an ATRP Method)

ATRP was performed for 24 hours in the same manner as in Example 1 by adding 7.8 g of an ethoxylated glycerin triacrylate monomer represented by Chemical Formula (15) (trade name: A-GLY-9E, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be was 2.2±0.1 nm (excluding the thickness of an SAM). In addition, the contact angle to water was measured and found to be 30±3°. FIGS. 6 and 7 show the results of the protein adsorption measurement.

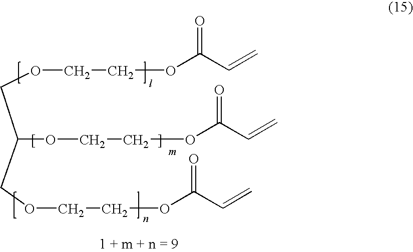

### Example 7

(Polymerizing Ethoxylated Glycerin Triacrylate (the total number of EG Units: 20) on the Surface of SAM by Means of an ATRP Initiator by Employing an ATRP Method)

ATRP was performed for 24 hours in the same manner as in Example 1 by adding 13.6 g of an ethoxylated glycerin triacrylate monomer represented by Chemical Formula (16) (trade name: A-GLY-20E, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 2.3±0.2 nm (excluding the thickness of an SAM). In addition, the contact angle to water was measured and found to be 21±3°. FIGS. 6 and 7 show the results of the protein adsorption measurement.

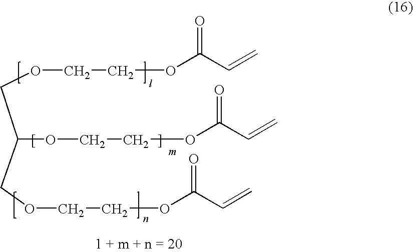

### Example 8

(Polymerizing an Amphoteric Ion-Containing Multi-Vinyl Monomer on the Surface of SAM by Means of an ATRP Initiator by Employing an ATRP Method)

1 equivalent of acid phosphoxy polyethylene glycol monomethacrylate (manufactured by Unichemical; trade name: Phosmer PE; the number of EG units: 4 to 5) and 1 equivalent of diethylaminoethyl monomethacrylate are mixed so that a methacryloyl polyethylene glycol acid phosphate diethylaminoethyl methacrylate half salt represented by Chemical Formula (17) (hereinafter “PEDM”) is produced by an acid-base reaction.

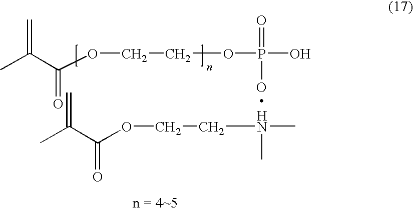

ATRP is performed for a predetermined time period in the same manner as in Example 1 by adding the PEDM instead of the NEGDA monomer after the introduction of an ATRP initiator onto a gold thin-film substrate. The resultant polymer is washed and dried by nitrogen purge. The dried membrane thickness of the polymer is measured in the same manner as in the above. As a result, a thickness necessary for the prevention of the adsorption is obtained. In addition, the contact angle to water is measured. As a result, a contact angle appropriate for the prevention of the adsorption is obtained. Further, protein adsorption measurement is performed to confirm that the adsorption of the polymer is lower than that of an existing membrane.

### Comparative Example 1

(Treating a Cleaned Gold Thin-Film Substrate with a Skim Milk Solution)

A gold thin-film substrate was cleaned in the same manner as in Example 1. After that, 10 ml of a hosphate buffer of 1% skim milk (pH: 7.4) was placed in a capped container. The cleaned gold thin-film substrate was washed with ultrapure water, and was then placed in the capped container, and stirring was carried out in a rotary incubator for 1 hour. Further, the substrate was cleaned with ultrapure water overnight, whereby the gold thin-film substrate the surface of which had been treated with skim milk was prepared. The substrate was dried by nitrogen purge, and subjected to protein adsorption measurement. FIGS. 6 and 7 show the results of the protein adsorption measurement.

### Comparative Example 2

(Treating a Cleaned Gold Thin-Film Substrate with Triethylene Glycol Undecanthiol (TEG-UT))

A gold thin-film substrate was cleaned in the same manner as in Example 1. After that, 10 ml of an ethanol solution of 1 μM TEG-UT (pH: 7.4) was placed in a capped container. The cleaned gold thin-film substrate was washed with ethanol, and was then placed in the capped container, and stirring was carried out in a rotary incubator for 1 hour. Further, the substrate was cleaned with ethanol overnight, whereby the gold thin-film substrate in which an SAM was formed on the surface by treatment with TECT-UT was prepared. The substrate was dried by nitrogen purge, and subjected to protein adsorption measurement. FIGS. 6 and 7 show the results of the protein adsorption measurement.

### Comparative Example 3

(Polymerizing Ethylene Glycol Dimethacrylate (EGDMA; the Number of EG Units: 1) on the Surface of SAM by Means of an ATRP Initiator by Employing an ATRP Method)

ATRP was performed for 6 hours in the same manner as in Example 1 by adding 0.60 g of a EGDMA monomer represented by Chemical Formula (18) (trade name: NK Ester 1G, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 9.5±0.3 nm (excluding the thickness of an SAM). In addition, the contact angle to water was measured and found to be 85±6°. FIGS. 6 and 7 show the results of the protein adsorption measurement.

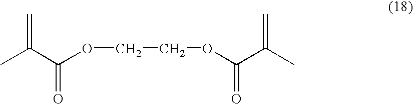

### Comparative Example 4

(Polymerizing Diethylene Glycol Dimethacrylate (DEGDMA; the number of EG Units: 2) on the Surface of SAM by Means of an ATRP Initiator by Employing an ATRP Method)

ATRP was performed for 3 hours in the same manner as in Example 1 by adding 0.36 g of a DEGDMA monomer represented by Chemical Formula (19) (trade name: NK Ester 2G, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 4.5±0.2 nm (excluding the thickness of an SAM). In addition, the contact angle to water was measured and found to be 64±3°. FIGS. 6 and 7 show the results of the protein adsorption measurement.

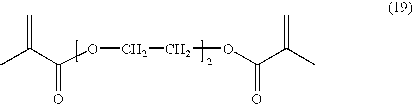

### Comparative Example 5

(Polymerizing Triethylene Glycol Dimethacrylate (TrEGDMA; the Number of EG Units: 3) on the Surface of SAM by Means of an ATRP Initiator by Employing an ATRP Method)

ATRP was performed for 3 hours in the same manner as in Example 1 by adding 0.86 g of a TrEGDMA monomer represented by Chemical Formula (20) (trade name: NK Ester 3G, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 23.2±0.1 nm (excluding the thickness of an SAM). In addition, the contact angle to water was measured and found to be 44±2°. FIGS. 6 and 7 show the results of the protein adsorption measurement.

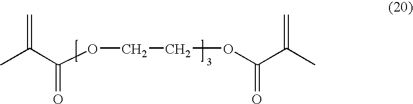

### Comparative Example 6

(Polymerizing Ethoxylated Glycerin Triacrylate (the total number of EG Units: 3) on the Surface of SAM by Means of an ATRP Initiator by Employing an ATRP Method)

ATRP was performed for 24 hours in the same manner as in Example 1 by adding 4.63 g of an ethoxylated glycerin triacrylate monomer represented by Chemical Formula (21) (trade name: A-GLY-3E, manufactured by Shin-Nakamura Chemical Co., Ltd.) instead of the NEGDA monomer after the introduction of an ATRP initiator onto a gold thin-film substrate. The resultant polymer was washed and dried by nitrogen purge. The dried membrane thickness of the polymer was measured in the same manner as in the above, and found to be 5.6±0.3 nm (excluding the thickness of an SAM). In addition, the contact angle to water was measured and found to be 45±3°. FIGS. 6 and 7 show the results of the protein adsorption measurement.

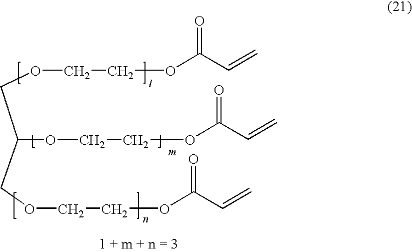

### Example 9

(IR-RAS Analysis of Polymer)

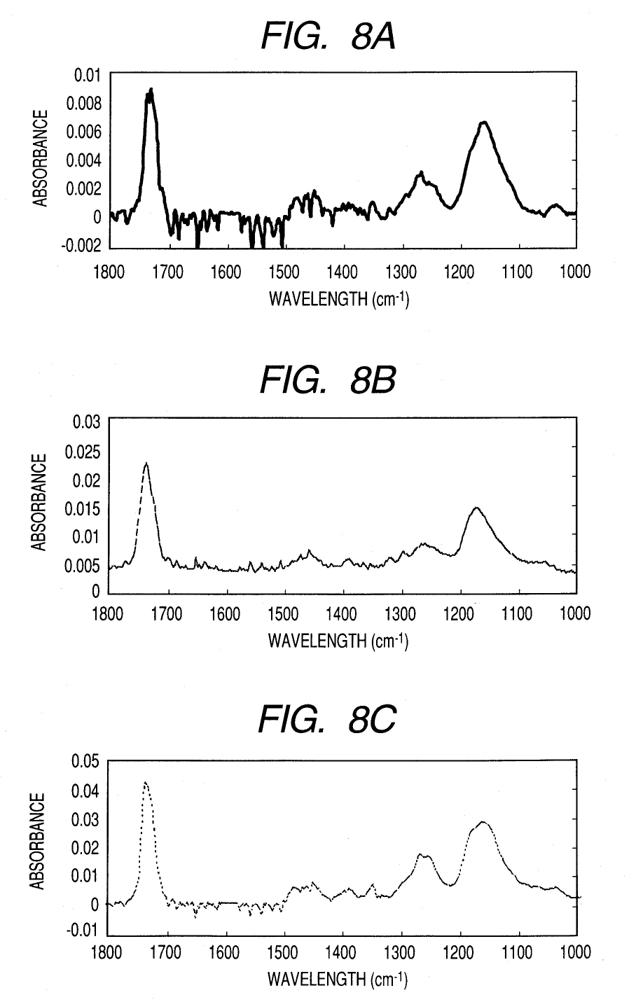

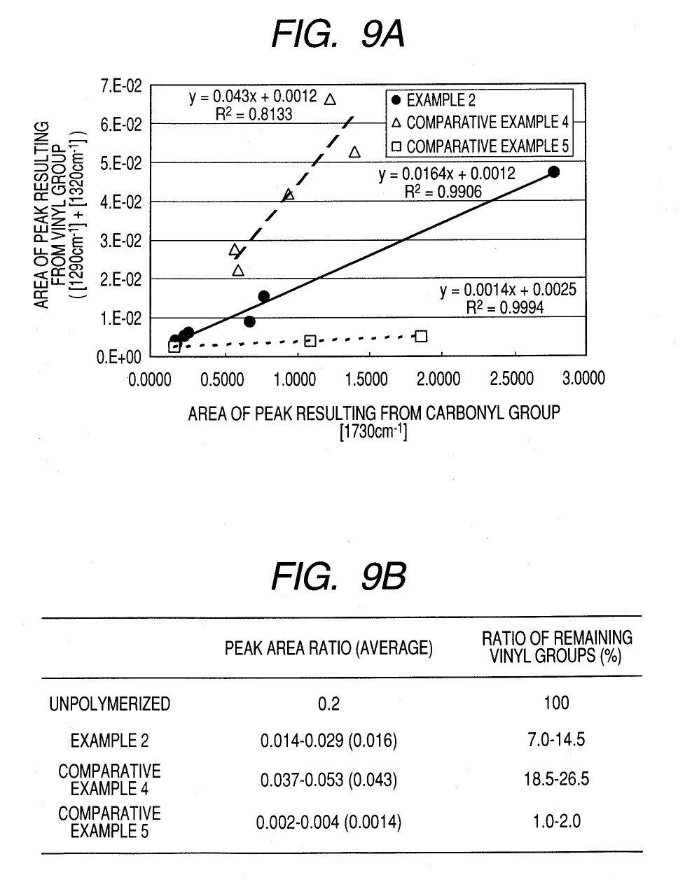

FIGS. 8A to 8C show the results of the IR-RAS analysis of polymers having different thicknesses obtained by changing reaction times for the polymers of Example 2, and Comparative Examples 4 and 5. FIG. 8A shows the result of the IR-RAS analysis of the polymer of Example 2, FIG. 8B shows the result of the IR-RAS analysis of the polymer of Comparative Example 4, and FIG. 8C shows the result of the IR-RAS analysis of the polymer of Comparative Example 5. Further, FIGS. 9A and 9B show the results of the quantitative determination of the remaining vinyl groups by using a peak derived from a carbonyl group as an internal standard.

In FIG. 9A, an axis of abscissa indicates the area of a peak derived from carbonyl groups near 1,730 cm⁻¹, and an axis of ordinate indicates the sum of the areas of peaks derived from remaining vinyl groups near 1,290 cm⁻¹ and 1,320 cm⁻¹. In addition, the IR-RAS analysis of a thin membrane spin-coated with a monomer was made, and based on the fact that a peak area ratio (([1,290 cm⁻¹]+[1,320 cm⁻¹])/[1,730 cm⁻¹]) was nearly equal to 0.2, the remaining vinyl groups of each polymer was quantitatively determined. FIG. 9B shows the results of the determination.

It can be seen that the remaining vinyl groups of the polymer in Example 2 is smaller than that of the polymer in Comparative Example 4. The ratio of the remaining vinyl groups of the polymer in Comparative Example 5 is extremely low. The remaining vinyl groups account for 2% or less of all the vinyl groups of the polymerized multi-vinyl monomer. This is a very rare case when compared with any other multi-vinyl monomers. The polymer extends at a high rate, and the ratio at which the monomer is crosslinked becomes high, but the degree of freedom in the polymer main chain and the degree of freedom in the entire polymer may be impaired.

In addition, the polymers in Examples 3 and 4 showed the remaining vinyl group amount at the same level as the polymer in Example 2. The polymer in Comparative Example 3 showed the remaining vinyl group amount not smaller than that in Comparative Example 4. In this case, the remaining vinyl groups account for 15% or more of all the vinyl groups of the polymerized multi-vinyl monomer. Therefore, excluding Comparative Example 5, it can be considered that reduction in the remaining vinyl groups results in an improvement in ability to prevent the adsorption of protein.

From the above results, it is considered that a polymer in which remaining vinyl groups account for 15% or less of all the vinyl groups of the polymerized multi-vinyl monomer has a high ability to prevent the adsorption of protein, and a polymer in which remaining vinyl groups account for preferably 2% to 15% of all the vinyl groups of the polymerized multi-vinyl monomer may have a higher ability to prevent the adsorption of a protein.

### INDUSTRIAL APPLICABILITY

The use of the structural member of the present invention in each of a reaction field and a flow path for a laboratory test such as a genetic test, a biochemical test, or an immunological test can prevent the nonspecific adsorption of contaminant in a sample. In addition, by covering the surface of a medical device such as a syringe or a catheter with the polymer in the present invention, a foreign-body reaction in a body can be inhibited. Further, the use of the target substance detecting element of the present invention in a molecular probe for medical imaging such as a contrast medium can not only suppress a foreign-body reaction in a body but also improve the dispersibility of the molecular probe. In addition, the present invention can be effectively used for the purpose of preventing clouding or stain on the surface of a material; for example, the surfaces of lens of, for example, cameras, video cameras, or insertion instruments for cataract therapy can be covered with the polymer in the present invention. In an example of the above group of applications, the structural member can be used in a magnetic biosensor.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-204703, filed Aug. 6, 2007, which is hereby incorporated by reference herein in its entirety.

1. A structural member comprising a substrate and a polymer present on a surface of the substrate,
wherein the polymer is formed from a polymer of a multi-vinyl monomer represented by the following general formula (I) or (II), and has a crosslinked structure: 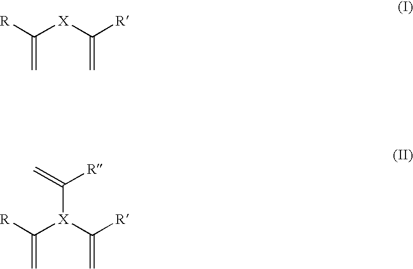
where R, R′, and R″ each independently represent a hydrogen atom or a methyl group, and X represents a hydrophilic functional group in which fifteen or more atoms are linked in series.

2. A structural member according to claim 1, wherein X contains a polymer of a bifunctional compound or of a cyclic compound are bonded.

3. A structural member according to claim 1, wherein X contains a group in which four or more units of polyethylene glycol.

4. A structural member according to claim 1, wherein the number of vinyl groups in the polymer is 15% or less of a total number of vinyl groups in the multi-vinyl monomer.

5. A method of producing a structural member comprising:
bringing a substrate and a polymerization initiator into contact with each other; and
bringing the substrate brought into contact with the polymerization initiator and a multi-vinyl monomer represented by one of the following general formula (I) or (II) into contact with each other to form a polymer by living polymerization: 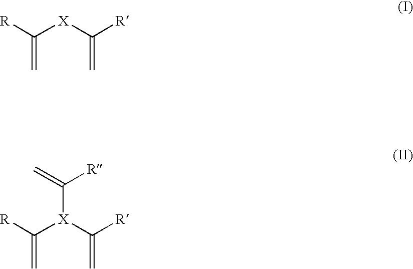
where R, R′, and R″ each independently represent a hydrogen atom or a methyl group, and X represents a hydrophilic functional group in which fifteen or more atoms are linked in series.

6. A method of producing a structural member according to claim 5, wherein the living polymerization is living radical polymerization.
